(19) United States
(12) Patent Application Publication
(10) Pub. No.: US 2022/0339076 A1
(43) Pub. Date: Oct. 27, 2022

(54) INFANT FEEDING BOTTLE AND VALVE SYSTEM THEREFOR

(71) Applicant: SAVVYBABY PTY LTD, Queensland (AU)

(72) Inventor: Mark KIEHNE, Queensland (AU)

(73) Assignee: SAVVYBABY PTY LTD, Queensland (AU)

(21) Appl. No.: 17/636,325

(22) PCT Filed: Aug. 19, 2020
(86) PCT No.: PCT/AU2020/000083

§ 371 Date: Feb. 17, 2022

(30) Foreign Application Priority Data
Aug. 19, 2019 (AU) 2019903001

(51) Int. Cl. A61J 11/00; A61J 11/04; A61J 9/08

(52) U.S. Cl. CPC A61J 11/0015; A61J 11/04; A61J 9/085

(57) ABSTRACT

A feeding bottle (100) including a reservoir (105) for receiving a liquid for feeding, a teat (115) for providing the liquid from the reservoir (105), a regulator (120) disposed between the reservoir (105) and the teat (115), the regulator (120) shaped to engage the teat (115), and a collar (110) configured to retain the teat (115) to the reservoir (105), wherein the collar (110) is adjustably movable relative to the reservoir (105), wherein movement of the collar (110) relative to the reservoir (105) moves the teat (115) relative to the regulator (120) which provides adjustable flow of liquid from the reservoir (105) through the regulator (120) to the teat (115).

### FIELD OF THE INVENTION

The present invention relates to infant feeding bottles and valve systems therefor. This application claims priority from Australian Provisional Patent Application 2019903001 entitled INFANT FEEDING BOTTLE AND VALVE SYSTEM THEREFOR filed 19 Aug. 2019, the entire specification of which is fully incorporated herein by reference.

### BACKGROUND OF THE INVENTION

Infant feeding bottles are often used to provide milk, or baby formula to infants as an alternative or supplement to breastfeeding. These infant feeding bottles generally comprise a reservoir, for receiving the milk or baby formula, and a teat, through which the infant may retrieve milk or baby formula by sucking thereon.

A problem, however, with many infant feeding bottles of the prior art is that a partial vacuum (low pressure) is created in the reservoir, which ultimately causes air to pass in through the teat and into the bottle. As a result, both milk and air are ingested by the infant which may cause colic.

Attempts have been made to overcome this problem by providing additional entry points that enable air to enter into the bottle as the baby is feeding. However, such bottles are generally complex (and thus can be difficult to clean) and are more prone to spilling.

A further problem with infant feeding bottles of the prior art is that significant pressure is provided at the teat according to the volume of liquid in the reservoir there above. This causes the teat to leak and may cause choking or coughing during feeding as the infant is unable to naturally control the flow rate of milk or infant formula. Furthermore, such bottles promote feeding that is unlike natural breastfeeding.

Certain attempts have been made to create infant feeding bottles that mimic natural breastfeeding, but these bottles generally do not mimic natural breastfeeding particularly well, and are also generally complex (and thus also difficult to clean).

As such, there is clearly a need for an improved infant feeding bottle and valve system therefor.

It will be clearly understood that, if a prior art publication is referred to herein, this reference does not constitute an admission that the publication forms part of the common general knowledge in the art in Australia or in any other country.

The present invention seeks to overcome or substantially ameliorate at least some of the deficiencies of the prior art, or to at least provide an alternative.

### SUMMARY OF THE INVENTION

The present invention is directed to an infant feeding bottle and valve system therefor, which may at least partially overcome at least one of the abovementioned disadvantages or provide the consumer with a useful or commercial choice.

The present invention provides a feeding bottle including:

a reservoir, for receiving a liquid for feeding;

a teat, for providing the liquid from the reservoir;

a regulator disposed between the reservoir and the teat, the regulator shaped to engage the teat; and

a collar configured to retain the teat to the reservoir, wherein the collar is adjustably movable relative to the reservoir,

wherein movement of the collar relative to the reservoir moves the teat relative to the regulator which provides adjustable flow of liquid from the reservoir through the regulator to the teat.

Preferably, the regulator is shaped to engage an internal surface of the teat to define a fluid flow gap therebetween, wherein movement of the collar increases or decreases the gap to provide the adjustable flow of liquid.

Preferably, the regulator is shaped such that movement of the collar provides a minimum flow configuration and a maximum flow configuration, and wherein the collar is movable to any position between the minimum and maximum flow configurations.

Preferably, the collar is movable to a position where the teat engages the regulator to provide a closed no-flow configuration, in which flow of liquid from the reservoir into the teat is prevented.

Preferably, the collar is rotationally adjustable by threaded engagement with the reservoir.

Preferably, the regulator is configured to separate the liquid in the reservoir from the liquid in the teat, such that in use the liquid in the reservoir does not pressurise the liquid in the teat.

Preferably, the regulator is configured to enable an air gap to be created between the liquid in the teat and the liquid in the reservoir.

Preferably, the regulator is configured to engage with a mouth of the reservoir such that all liquid flows through the regulator.

Preferably, the teat includes an anti-vacuum aperture in a base portion thereof, to enable air to enter the reservoir independently of an opening of the teat.

Preferably, an air chamber is defined between a base portion of the teat and the collar, wherein in use air enters from under the collar into the air chamber and into the reservoir via the anti-vacuum aperture.

Preferably, a channel is defined in an upper surface of the base portion of the teat to provide access to the air chamber from the collar of the bottle.

Preferably, the regulator includes a dome shaped portion which is configured to be received on and engage an inside of the teat, wherein the dome shaped portion defines a gap with the teat, and movement of the collar increases or decreases the gap therebetween to provide the adjustable flow of liquid from the reservoir through the regulator to a nozzle of the teat.

Preferably, ribs extend outwardly from the dome shaped portion to further retain the teat, the ribs being spaced to define liquid passages therebetween.

Preferably, the regulator includes apertures through which the liquid may flow, and the collar is configured to press a base of the teat against the apertures to thereby seal the apertures in the closed configuration.

Preferably, the collar includes an annular rib at a lower surface thereof which engages and moves the base of the teat.

Preferably, the teat includes a base flange having an annular sealing rib on its underside and the regulator includes an annular rim on its upper side adapted for cooperation around its periphery with said annular sealing rib.

Preferably, the regulator includes an annular rib on its underside which is receivable within a mouth of the reservoir to seal therewith.

Preferably, the bottle and the collar include corresponding stop means configured to define the minimum and maximum flow limit stops of the collar.

Preferably, an external surface of a sidewall of the regulator includes air passages to allow air from under the collar to enter the air chamber in use.

The invention in another aspect provides a valve system for a feeding bottle including a reservoir for receiving a liquid for feeding and a teat for providing the liquid from the reservoir, the valve system comprising:

a regulator to be disposed between the reservoir and the teat, the regulator shaped to engage the teat; and

a collar configured to retain the teat to the reservoir, wherein the collar can be adjustably movable relative to the reservoir,

wherein movement of the collar relative to the reservoir in use moves the teat relative to the regulator which provides adjustable flow of liquid from the reservoir through the regulator to the teat.

Preferably, the regulator is configured to provide at least a first flow configuration and a second flow configuration, the first and second flow configurations configured to flow liquid from the reservoir into the teat at different rates.

Preferably, the regulator is further configured to provide a closed (no-flow) configuration, in which flow of liquid from the reservoir into the teat is prevented.

Preferably, the collar is adjusted by rotation. Such configuration may provide continuous adjustment between a fully open and a fully closed configuration.

Preferably, the dome shaped portion may be hemispherical in shape. A height of the dome shaped portion may be about the size of a radius of the dome shaped portion. A height of the dome shaped portion may be at least half of the size of the radius of the dome shaped portion.

Suitably, rotation of the collar causes movement of the teat along its axis to engage with the regulator and provide adjustment of flow rate thereby. The collar may include threads which engage with threads of the reservoir.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings in which:

FIG. 1 illustrates an exploded view of an infant feeding bottle, according to an embodiment of the present invention.

FIG. 2a illustrates an upper side perspective view of a regulator of the feeding bottle of FIG. 1.

FIG. 2b illustrates a top view of the regulator of the feeding bottle of FIG. 1.

FIG. 2c illustrates a bottom view of the regulator of the feeding bottle of FIG. 1.

FIG. 2d illustrates a side perspective view of the regulator of the feeding bottle of FIG. 1.

FIG. 2e illustrates a side view of the regulator of the feeding bottle of FIG. 1.

FIG. 3a illustrates an upper side perspective view of a collar of the feeding bottle of FIG. 1.

FIG. 3b illustrates a side view of the collar of the feeding bottle of FIG. 1.

FIG. 3c illustrates a top view of the collar of the feeding bottle of FIG. 1.

FIG. 3d illustrates a bottom view of the collar of the feeding bottle of FIG. 1.

FIG. 4a illustrates a side view of a teat of the feeding bottle of FIG. 1.

FIG. 4b illustrates a top view of the teat of the feeding bottle of FIG. 1.

FIG. 4c illustrates an upper perspective view of the teat of the feeding bottle of FIG. 1.

FIG. 5a illustrates an interaction between the teat and the regulator of the feeding bottle of FIG. 1 in an open configuration.

FIG. 5b illustrates an interaction between the teat and the regulator of the feeding bottle of FIG. 1 in a closed configuration.

FIG. 6 illustrates the feeding bottle of FIG. 1, in use.

### DESCRIPTION OF EMBODIMENTS

It should be noted in the following description that like or the same reference numerals in different embodiments denote the same or similar features.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

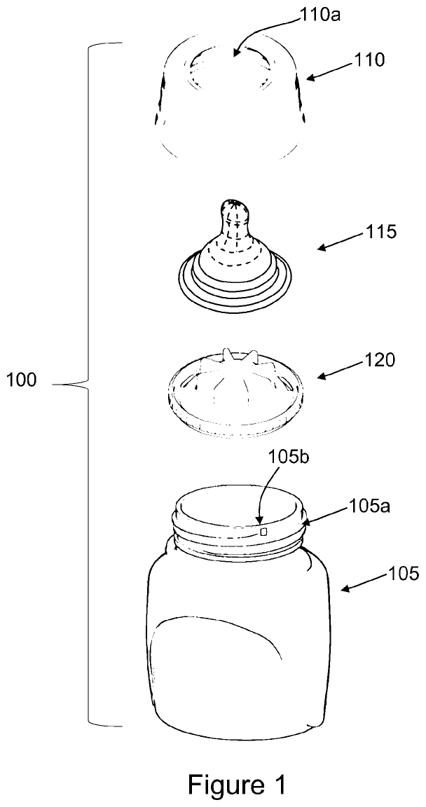

FIG. 1 illustrates an exploded view of an infant feeding bottle 100, according to an embodiment of the present invention. Milk or formula may be provided in the infant feeding bottle 100 and consumed by an infant such that it mimics breastfeeding. In particular, in use any significant positive pressure (e.g. caused by gravity) or negative pressure (e.g. caused by partial vacuum) in the bottle is avoided. As a result, the infant feeding bottle is able to reduce colic and feeding problems in infants.

The infant feeding bottle 100 includes a reservoir 105, for receiving liquid, such as milk, formula, water, juice, or the like. The reservoir 105 includes an externally threaded neck 105a, which couples to an internally threaded neck 110a of a collar 110. A teat 115 and a regulator 120 are received between, and held in place by, engagement of the collar 110 with the reservoir 105.

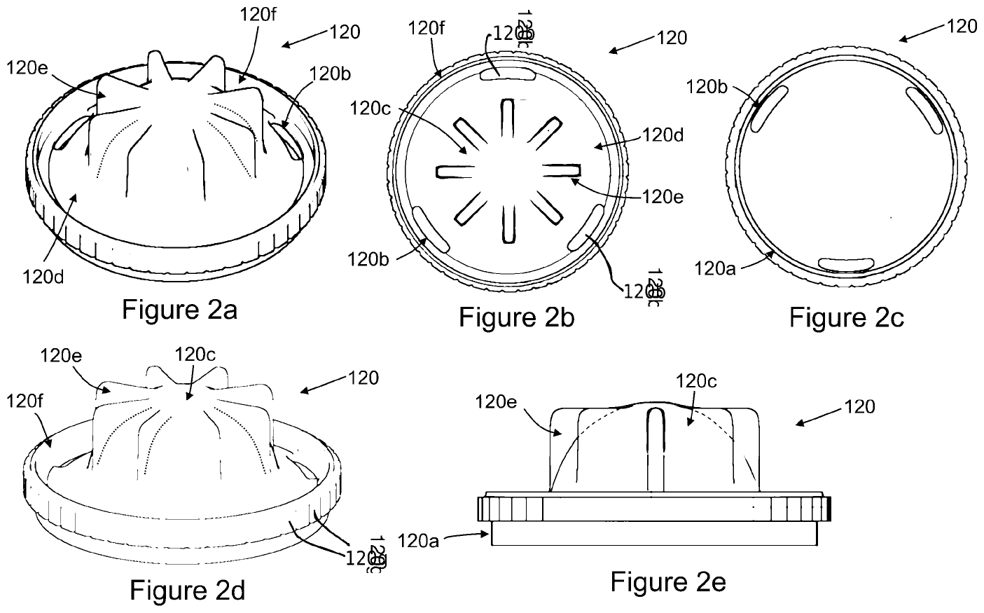

As best illustrated in FIGS. 2a-2e, the regulator 120 includes a base 120d having a short height upwardly extending peripheral sidewall 120f, a short height downwardly extending annular flange 120a extending from a lower surface of the base 120d, and a central dome portion 120c which extends upwardly from a base 120d of the regulator.

The annular flange 120a is configured to be received in and engage inner surface of a mouth of the reservoir 105, such that flow of liquid from the reservoir 105 is entirely through the regulator 120. Apertures 120b are provided in a spaced manner in the base 120d around a periphery of the regulator 120, to enable a flow of liquid from the reservoir 105 and through the regulator 120. The embodiment provides three generally slot shaped apertures 120b spaced at 120° relative to the center of the regulator 120. The apertures 120b are formed slightly inwardly from the annular flange 120a.

The central dome portion 120c extends upwardly from the base 120d at a steep angle and in use provides adjustable flow control with the teat 115 as described below. Furthermore, the dome portion 120c comprises a plurality of spaced ribs 120e which extend diametrically from a centre of the dome portion 120c. The ribs 120e are spaced around the dome portion 120c and have side edges extending upwardly from edges of the dome portion 120c and top edges extending outwardly from a centre of the dome portion 120. The spaces between the ribs 120e allow fluid flow therebetween in use. The ribs 120e in use also prevent the teat 115 from being dislodged from the bottle 100 as they prevent force being applied to a base of the teat 115 in a lateral direction as further described below. An external surface of the sidewall 120f includes spaced ribs 120g which provides small air passages therebetween to allow air from under the collar to enter in use as described below.

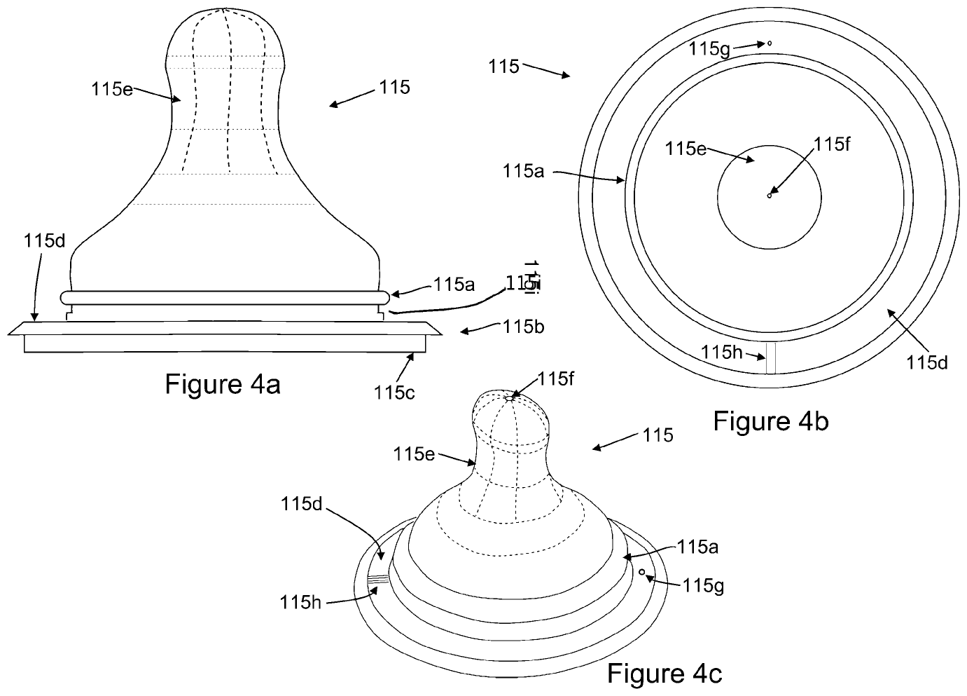

As best illustrated in and FIGS. 4a-4c, the teat 115 includes a base portion 115b and an annular retainer 115a spaced above the base portion 115b. A channel 115i is defined between the base portion 115b and the annular retainer of the teat 115, the channel 115i being configured to retain the teat 115 to the collar 110.

The teat 115 further includes an annular base flange 115c extending downwardly from the base portion 115b, the base flange 115c is configured to be received within upper sidewalls 120f of the regulator 120. The base portion 115b further includes an upper planar portion 115d above the annular base flange 115c. An upper end of the teat 115 tapers to a nozzle 115e having one or more outlets 115f therein, for providing the liquid to the infant in use.

The teat 115 further includes an anti-vacuum aperture 115g formed in the base portion 115b and channel 115h formed in the upper planar portion 115d, to enable air to flow into the reservoir 105 from up through an underside of the collar 110, to prevent a low-pressure condition being provided in the reservoir 105. As such, in use, air enters the reservoir 105 through the anti-vacuum aperture 115g rather than back through the outlet 115f of the teat 115.

The annular base flange 115c is configured to space the upper planar portion 115d above the apertures 120b of the regulator 120, to allow liquid to flow through the apertures 120b from the reservoir 105 to the teat 115. The diameter of the annular base flange 115c is about the same as an inner diameter of the sidewalls 120f such that the teat 115 can be sealingly received therein.

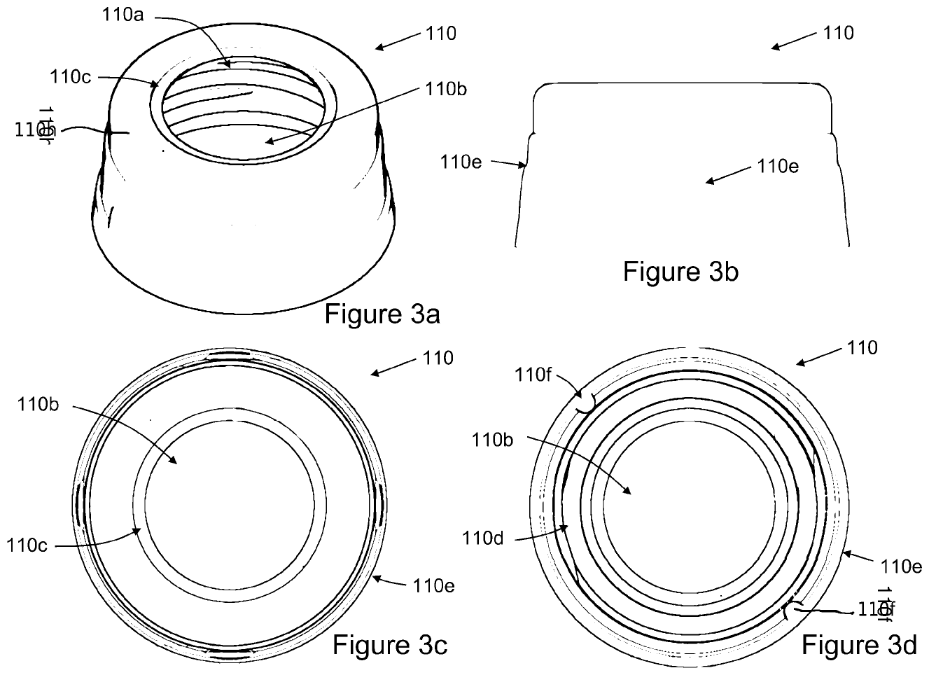

As best illustrated in FIGS. 3a-3d, the collar 110 includes a ring shaped upper portion 110h and an internally threaded outer wall 110e extending downwardly around a periphery of the upper portion 110h. The upper portion includes a central opening 110b having an annular upper flange 110c on an upper side of the opening 110b and extending around an interior thereof. In use, the teat 115 is pulled through the opening 110b from the bottom such that the annular retainer 115a is positioned on an upper edge of the annular flange 110c. As such, the annular upper flange 110c is received within the channel 115i defined by the annular retainer 115a, and the teat 115 is thereby retained in the collar 110.

The collar 110 further includes an annular lower rib 110d formed in a lower surface of the upper portion 110h, spaced intermediate the opening 110b and the outer wall 110e of the collar 110, the annular lower rib extending downwardly from an underside of the collar upper portion 110h. In use, the annular rib 110d is configured to engage with an upper side of the upper planar portion 115d of the teat 115, as described in further detail below.

The collar 110 has projections 110e spaced around its periphery to assist with gripping and turning. Furthermore, a pair of radially enlarged stop members 110f are provided on an inside of the wall 110e of the collar 110 and adjacent to the lower edge thereof. The stop members 110f are adapted for engagement with corresponding stop members 105b of the reservoir 105. Cooperation and engagement between the respective stop members 105a and 110f defines limits of rotation of the collar 110 relative to the reservoir 105 to provide adjustment of a flow of liquid from the reservoir 105 into the teat 115. The stop members 105b and 110f define fully open and fully closed states of the bottle 100, and various levels of flow are provided therebetween. The collar 110 in the fully closed state is close to a full tightened rotation with the bottle 100. In the fully open position, the collar 100 is slightly unwound from the bottle 100. The annular flange 120a of the regulator 120 is fitted tightly into the mouth of the bottle 100 to avoid spillage.

The teat 115 is hollow and an internal diameter of the teat 115 is substantially the same diameter as the base of the central dome portion 120c. As such, the dome portion 120c is able to be received snugly in the teat 115.

The apertures 120b are slot shaped and extend around the central dome portion 120c such that in use the upper planar portion 115d is positioned directly above the apertures 120b.

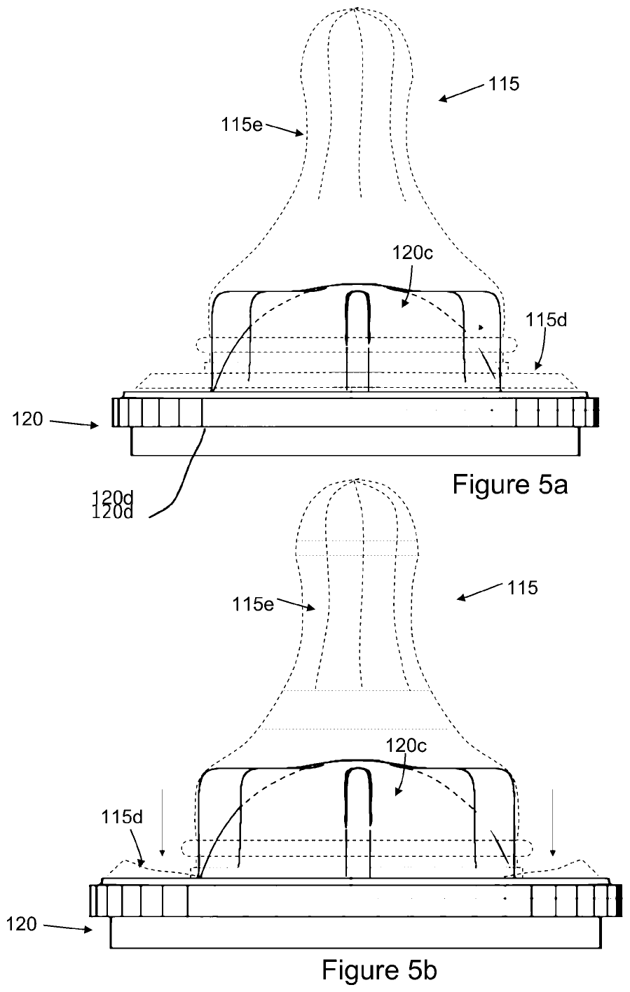

FIG. 5a illustrates the teat 115 with respect to the regulator 120 in a fully open configuration. The dome portion 120c projects into an inside of the teat 115, and the teat is held in place by the base flange 115c such that a space is defined between the base 120d and the domed portion 120c and an inside of the teat 115. As such, liquid is able to flow from the reservoir 105 through the apertures 120b, and up between the domed portion 120c and an inside wall of the teat 115 (between the ribs 120e) to fill the nozzle 115e of the teat 115, as indicated by the arrows.

FIG. 5b illustrates the teat 115 with respect to the regulator 120 in a partially closed configuration. In particular, as the collar 110 is screwed down onto the reservoir 105, the inner annular rib 110d, which is positioned on the underside of the collar 110 and around a periphery of the opening 110b, pushes the upper planar portion 115d downwardly, as indicated by the arrows, which in turn pulls down the entire teat 115 downwards with respect to the domed portion 120c.

The inside of the teat 115 and the domed portion 120c of the regulator 120 control a flow rate of liquid from the reservoir 115 as a gap between an inside of the teat 115 and the domed portion 120c is reduced as the teat 115 is pulled downwardly. Furthermore, as the collar 110 is turned to a fully closed position, the upper planar portion 115d of the teat is ultimately pushed so far downwards that it seals against the apertures 120b of the regulator 120 and thus acts as a plug to sealingly engage with the apertures 120b.

The regulator 120 disposed between the reservoir 105 and the teat 115 is thus shaped to engage the teat 115 (internal surfaces) and the collar 110 is configured to retain the teat 115 to the reservoir 105. The collar 110 is adjustably movable (by threaded engagement rotation) relative to the reservoir 105. Rotation movement of the collar 110 relative to the reservoir 105 moves the teat 115 relative to the regulator 120 which increases or decreases the gap therebetween to provide adjustable flow of liquid from the reservoir 105 through the regulator 120 to the teat 115. Rotation of the collar 110 causes movement of the teat 115 along its axis to engage with the regulator 120 and provide the flow rate adjustment.

As outlined above, the anti-vacuum aperture 115g and channel 115h enable air to flow into the reservoir 105 from up through an underside of the collar 110, to prevent a low pressure condition being provided in the reservoir 105. In particular, a small, annular air chamber is defined between the upper planar portion 115d and an underside of the upper portion 110h of the collar 110, between the annular flange 110c and the upper planar portion 115d.

Air flows from an underside of the collar 110 and through the small air passages formed by the spaced ribs 102g of the sidewall 120f. The channel 115h in the upper planar portion 115d enables the air to flow into the small annular air chamber, which extends around the teat, and down through the aperture 115g into the reservoir 100.

Such configuration enables the pressure inside the small annular air chamber to adjust synchronously with feeding, thus preventing abrupt changes or oscillations in pressure that may otherwise occur, thus allowing the bottle to mimic a mother's breast more accurately.

When the bottle is closed (i.e. the collar 110 is screwed down onto the reservoir 105), the inner annular rib 110d of the collar 110 pushes downwardly on the channel 115h and thus closes the channel 115h by deformation. As a result, air is unable to enter the small annular air chamber defined under the collar 110, and liquid is unable to exit the bottle in the reverse direction, thus preventing leaks.

In use, the reservoir 115 is filled with liquid, and the regulator 120 is engaged with the mouth of the reservoir by positioning the annular flange 120a of the regulator into the mouth of the reservoir. The teat 115 is coupled with the collar 110 so that the nozzle 115e protrudes through the opening 110b in the collar 110 such that the annular retainer 115a retains the teat 115 against the annular flange 110c, as outlined above. The collar 110 is then screwed onto the neck of the reservoir 105 through engagement between the cooperating threads 105a and 110a.

The collar 110 may then be placed in a desired position with reference to the reservoir 105, such as a closed position if the bottle 100 is to be stored to transported prior to use, or in a partially opened position if the bottle 100 is to be immediately used.

As the central dome portion 120c extends upwardly from the regulator 120 at a steep angle and substantially into the teat 115, the regulator 120 is not only able to block and seal an entrance into the teat 115, but is able to gradually regulate a flow of fluid into the teat 115. As such, the bottle 110 functions as a main reservoir in the reservoir 105, and a feeding reservoir in the teat 115, where the rate of flow of liquid from the main reservoir to the feeding reservoir is adjustable. As the main reservoir will generally hold much more liquid than the feeding reservoir (e.g. about 200 ml vs about 20 ml), the pressure of the liquid at the teat 115 is much lower than if a regulator 120 had not been used.

Furthermore, as the feeding rate of babies varies, the flow rate from the reservoir 105 into the teat 115 can be adjust accordingly.

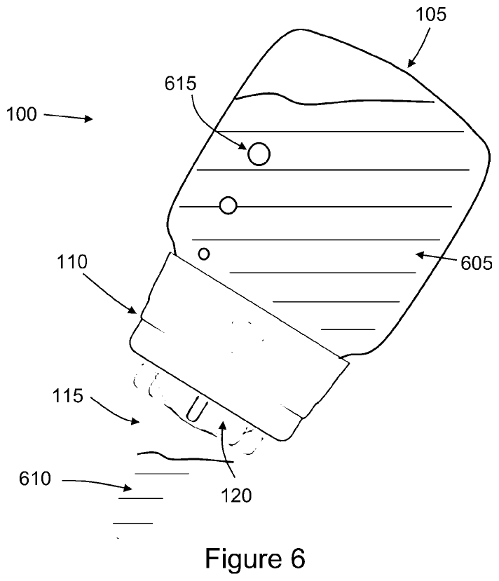

FIG. 6 illustrates the bottle 100 in a feeding configuration, illustrating a main reservoir of liquid 605 in the reservoir 105, and a much smaller feeding reservoir of liquid 610 in the teat 115.

In use, liquid is sucked from the teat 115 through the opening. At the same time, liquid flows from the reservoir 105 into the teat 115 at a controlled rate, as outlined above. As the liquid flows out of the reservoir 105, air is able to pass up through the threads of the collar 110 and into the reservoir through the anti-vacuum aperture 115g in the teat 115, as indicated by air bubbles 615.

As such, the teat 115 is basically unpressured, which is less likely to cause spills and much more resembles milk from a breast than a bottle where the liquid at the teat is pressurised. Any tendency for air from the outside environment to try and enter through the openings of the teat 115 is removed, thus reducing the likelihood that air is ingested with the liquid.

The teat 115 is made of a resilient plastic or rubber material and the reservoir 105, the regulator 120 and the collar 110 are formed of substantially rigid material.

While not illustrated, graduated indicia are provided on the side of the collar 110 and/or the reservoir 105 to illustrate a level of flow of the bottle 100. As such, the user (e.g. a parent) is able to quickly reconfigure the bottle 100 after cleaning or upon use.

The bottle 100 described above provides an effective means for providing a feeding environment that mimics breast feeding and allows an infant to feed instinctively and be consumed at natural pressure. The bottle 100 that can be adjusted to suit the development of the infant, and/or a thickness of the liquid. When closed, the bottle 100 is leak resistant, as liquid flow from the reservoir 105 is prevented. The venting system self regulates pressure smoothly and as such the flow rate of the bottle is consistent.

Furthermore, the bottle 100 is easy to clean, and as the liquid in the teat 115 is separated from the liquid in the reservoir 105, contamination of the liquid in the bottle 100 is greatly reduced.

Before feeding it is common practice for the user to pinch the end of the teat and shake the bottle to ensure heat distribution and formula mixing consistency. The bottle 100 may simply be closed (as described above), and shaken, the alleviating the need to contaminate the end of the teat.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment.

Furthermore, the particular features, structures, or characteristics may be combined in any suitable manner in one or more combinations. In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

The regulator disc incorporating the raised dome controls flow through the base of the teat and the dome and the raised fins thereof also act as a stop to prevent the teat from being pulled out of the collar by the baby drinking.

The collar that retains the teat screws on the bottle has a raised rib on the underside of the top portion thereof that when the teat is pulled through, the flange becomes angled that allows the teat flange to seal on the regulator disc during rotation (raising and lowering) with tension.

The configuration also creates a chamber (when teat is fitted) for air to travel around to the venting hole from the raised bumps on the flange in the flange of the teat making the venting system anti drip.

The collar has locating bumps that interferes with the bottle bumps to give a stop point or for full open. The bottle has bumps that interfere with the bumps on the collar for a stop reference or for full open feed.

Although a preferred embodiment of the present invention has been described, it will be apparent to skilled persons that modifications can be made to the embodiment shown.

The claims defining the invention are as follows:

1. A feeding bottle including:
a reservoir, for receiving a liquid for feeding;
a teat, for providing the liquid from the reservoir;
a regulator disposed between the reservoir and the teat, the regulator shaped to engage the teat; and
a collar configured to retain the teat to the reservoir, wherein the collar is adjustably movable relative to the reservoir,
wherein movement of the collar relative to the reservoir moves the teat relative to the regulator which provides adjustable flow of liquid from the reservoir through the regulator to the teat.

2. The feeding bottle of claim 1 wherein the regulator is shaped to engage an internal surface of the teat to define a fluid flow gap therebetween, wherein movement of the collar increases or decreases the gap to provide the adjustable flow of liquid.

3. The feeding bottle of claim 2 wherein the regulator is shaped such that movement of the collar provides a minimum flow configuration and a maximum flow configuration, and wherein the collar is movable to any position between the minimum and maximum flow configurations.

4. The feeding bottle of claim 3 wherein the collar is movable to a position where the teat engages the regulator to provide a closed no-flow configuration, in which flow of liquid from the reservoir into the teat is prevented.

5. The feeding bottle of claim 1 wherein the collar is rotationally adjustable by threaded engagement with the reservoir.

6. The feeding bottle of claim 1 wherein the regulator is configured to separate the liquid in the reservoir from the liquid in the teat, such that in use the liquid in the reservoir does not pressurise the liquid in the teat.

7. The feeding bottle of claim 6 wherein the regulator is configured to enable an air gap to be created between the liquid in the teat and the liquid in the reservoir.

8. The feeding bottle of claim 1 wherein the regulator is configured to engage with a mouth of the reservoir such that all liquid flows through the regulator.

9. The feeding bottle of claim 1 wherein the teat includes an anti-vacuum aperture in a base portion thereof, to enable air to enter the reservoir independently of an opening of the teat.

10. The feeding bottle of claim 9 wherein an air chamber is defined between a base portion of the teat and the collar, wherein in use air enters from under the collar into the air chamber and into the reservoir via the anti-vacuum aperture.

11. The feeding bottle of claim 10 wherein a channel is defined in an upper surface of the base portion of the teat to provide access to the air chamber from the collar of the bottle.

12. The feeding bottle of claim 1 wherein the regulator includes a dome shaped portion which is configured to be received on and engage an inside of the teat, wherein the dome shaped portion defines a gap with the teat, and movement of the collar increases or decreases the gap therebetween to provide the adjustable flow of liquid from the reservoir through the regulator to a nozzle of the teat.

13. The feeding bottle of claim 12 wherein ribs extend outwardly from the dome shaped portion to further retain the teat, the ribs being spaced to define liquid passages therebetween.

14. The feeding bottle of claim 4 wherein the regulator includes apertures through which the liquid may flow, and the collar is configured to press a base of the teat against the apertures to thereby seal the apertures in the closed configuration.

15. The feeding bottle of claim 14 wherein the collar includes an annular rib at a lower surface thereof which engages and moves the base of the teat.

16. The feeding bottle of claim 1 wherein the teat includes a base flange having an annular sealing rib on its underside and the regulator includes an annular rim on its upper side adapted for cooperation around its periphery with said annular sealing rib.

17. The feeding bottle of claim 1 wherein the regulator includes an annular rib on its underside which is receivable within a mouth of the reservoir to seal therewith.

18. The feeding bottle of claim 3 wherein the bottle and the collar include corresponding stop means configured to define the minimum and maximum flow limit stops of the collar.

19. The feeding bottle of claim 10 wherein an external surface of a sidewall of the regulator includes air passages to allow air from under the collar to enter the air chamber in use.

20. A valve system for a feeding bottle including a reservoir for receiving a liquid for feeding and a teat for providing the liquid from the reservoir, the valve system comprising
a regulator to be disposed between the reservoir and the teat, the regulator shaped to engage the teat; and
a collar configured to retain the teat to the reservoir, wherein the collar can be adjustably movable relative to the reservoir,
wherein movement of the collar relative to the reservoir in use moves the teat relative to the regulator which provides adjustable flow of liquid from the reservoir through the regulator to the teat.
